(19) United States
(12) Patent Application Publication
(10) Pub. No.: US 2025/0004741 A1
(43) Pub. Date: Jan. 2, 2025

(54) STATE-AWARE CONTINUOUS INTEGRATION

(71) Applicant: Red Hat, Inc., Raleigh, NC (US)

(72) Inventor: Filip Hubik, Brno (CZ)

(21) Appl. No.: 18/216,130

(22) Filed: Jun. 29, 2023

(51) Int. Cl. G06F 8/65; G06F 8/71

(52) U.S. Cl. CPC G06F 8/65; G06F 8/71

(57) ABSTRACT

State-aware continuous integration is provided by receiving, at a server from a first worker node, a committed update to an image stored in a central image pool accessible by a plurality of worker nodes that includes the first worker node; identifying a dependency for the committed update to a baseline state of the image to which the committed update applies changes; adding the committed update as a new state for the image to the central image pool; updating a structure for the image according to the dependency for the new state to the baseline state; and publishing the structure to the plurality of worker nodes to indicate that the new state is available for use in developing the image as a candidate baseline state.

### BACKGROUND

Continuous integration, as a part of continuous integration/continuous delivery (CI/CD), is a set of processes to automate and integrate code changes and updates to help software development teams composed of several team members with write permission to a code base to deliver code changes more frequently and reliably. Continuous delivery, as part of CI/CD, refers to the ability to push new software into production or the hands of team members with read access to a code base. These processes may be automated to give development teams more time to develop code, rather than spending time on the technical processes of delivery and managing code versions.

### SUMMARY

The present disclosure provides a new and innovative way to handle builds for continuous integration. Traditional software development tools for continuous integration/continuous delivery (CI/CD) help to drive and automate the Quality Engineering processes for software development of basically every software project nowadays. These tools help with development, deliver incremental improvements on a periodic basis, and ensure quick feedback on the code and output metrics for various engineering roles and the software lifecycle itself. Many of these tools have become “industry standards” and have a critical role in maintaining the product validation and verification and overall quality of software, and are used widely for product testing on various levels from the simplest components/units of software, to the most complex tasks like integration or regression testing of multi-component products. These traditional tools can take care of infrastructure preparation and management to support and simplify the testing being done, but are often wasteful in how computing resources are spent; repeating and duplicating work processes across various distributed user devices. In contrast, state-aware continuous integration, as discussed herein, avoids repetitive build tasks, and centralizes the storage and processing operations, thereby reducing the duplicative use of processor cycles and speeds up test and acceptance cycles, among other benefits.

In one example, a method is provided that comprises receiving, at a server from a first worker node, a committed update to an image stored in a central image pool accessible by a plurality of worker nodes that includes the first worker node; identifying a dependency for the committed update to a baseline state of the image to which the committed update applies changes; adding the committed update as a new state for the image to the central image pool; updating a structure for the image according to the dependency for the new state to the baseline state; and publishing the structure to the plurality of worker nodes to indicate that the new state is available for use in developing the image as a candidate baseline state.

In one example, a system is provided that comprises a processor; and a memory, including instructions that when executed by the processor perform operations including: receiving, at a server from a first worker node, a committed update to an image stored in a central image pool accessible by a plurality of worker nodes that includes the first worker node; identifying a dependency for the committed update to a baseline state of the image to which the committed update applies changes; adding the committed update as a new state for the image to the central image pool; updating a structure for the image according to the dependency for the new state to the baseline state; and publishing the structure to the plurality of worker nodes to indicate that the new state is available for use in developing the image as a candidate baseline state.

In one example, a memory device is provided that includes instructions that when executed by a processor perform operations including: receiving, at a server from a first worker node, a committed update to an image stored in a central image pool accessible by a plurality of worker nodes that includes the first worker node; identifying a dependency for the committed update to a baseline state of the image to which the committed update applies changes; adding the committed update as a new state for the image to the central image pool; updating a structure for the image according to the dependency for the new state to the baseline state; and publishing the structure to the plurality of worker nodes to indicate that the new state is available for use in developing the image as a candidate baseline state.

Additional features and advantages of the disclosed methods, devices, and/or systems are described in, and will be apparent from, the following Detailed Description and the Figures.

### BRIEF DESCRIPTION OF THE FIGURES

FIG. 1 illustrates a high-level component diagram of a computer system, according to examples of the present disclosure

FIG. 2 illustrates a distributed computing environment, according to embodiments of the present disclosure.

FIG. 3 illustrate a logical division of images states, according to embodiments of the present disclosure.

FIG. 4 illustrates a build environment, according to embodiments of the present disclosure.

FIG. 5 is a flowchart of an example method for providing state-aware continuous integration, according to embodiments of the present disclosure.

FIG. 6 is a flowchart of an example method for using state-aware continuous integration, according to embodiments of the present disclosure.

### DETAILED DESCRIPTION

The present disclosure provides a new and innovative way to handle builds for continuous integration. Traditional software development tools for continuous integration/continuous delivery (CI/CD) help to drive and automate the Quality Engineering processes for software development of basically every software project nowadays. These tools help with development, deliver incremental improvements on a periodic basis, and ensure quick feedback on the code and output metrics for various engineering roles and the software lifecycle itself. Many of these tools have become “industry standards” and have a critical role in maintaining the product validation and verification and overall quality of software, and are used widely for product testing on various levels from the simplest components/units of software, to the most complex tasks like integration or regression testing of multi-component products. These traditional tools can take care of infrastructure preparation and management to support and simplify the testing being done, but are often wasteful in how computing resources are spent; repeating and duplicating work processes across various distributed user devices. In contrast, state-aware continuous integration, as discussed herein, avoids repetitive build tasks, and centralizes the storage and processing operations, thereby reducing the duplicative use of processor cycles and speeds up test and acceptance cycles, among other benefits.

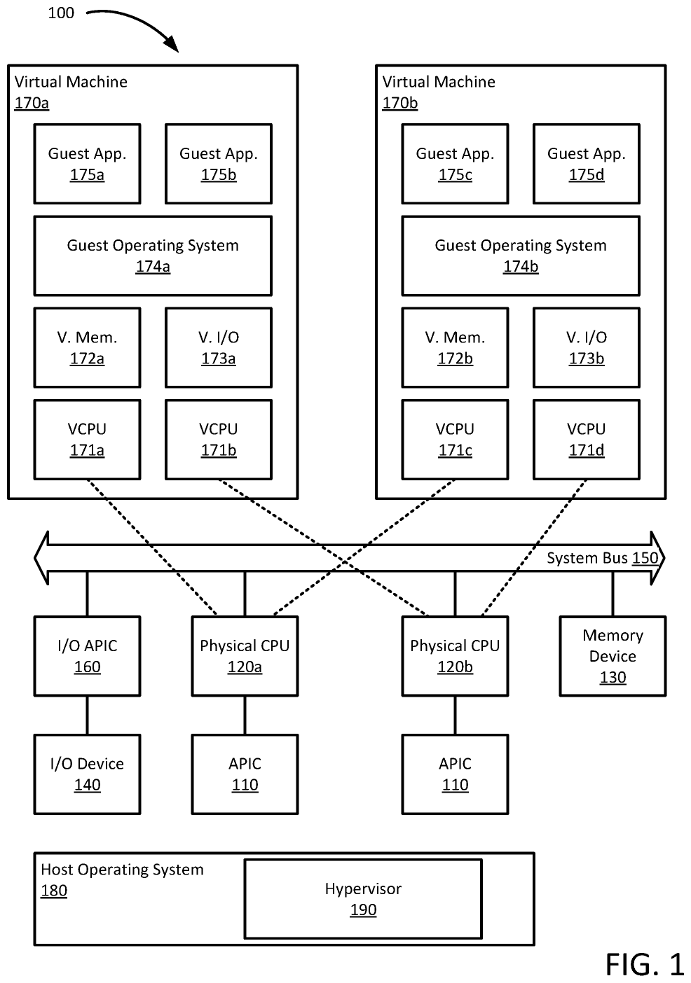

FIG. 1 illustrates a high-level component diagram of a computer system 100, according to examples of the present disclosure. The computer system 100 may include one or more physical central processing units (PCPUs) 120a-b (generally or collectively, processors or PCPUs 120) communicatively coupled to memory devices 130, and input/output (I/O) devices 140 via a system bus 150.

In various examples, the PCPUs 120 may include various devices that are capable of executing instructions encoding arithmetic, logical, or I/O operations. In an illustrative example, a PCPU 120 may follow Von Neumann architectural model and may include an arithmetic logic unit (ALU), a control unit, and a plurality of registers. In another aspect, a PCPU 120 may be a single core processor which is capable of executing one instruction at a time (or process a single pipeline of instructions), or a multi-core processor which may simultaneously execute multiple instructions. In another aspect, a PCPU 120 may be implemented as a single integrated circuit, two or more integrated circuits, or may be a component of a multi-chip module (e.g., in which individual microprocessor dies are included in a single integrated circuit package and hence share a single socket).

In various examples, the memory devices 130 include volatile or non-volatile memory devices, such as RAM, ROM, EEPROM, or any other devices capable of storing data. In various examples, the memory devices 130 may include on-chip memory for one or more of the PCPUs 120.

In various examples, the I/O devices 140 include devices providing an interface between a PCPU 120 and an external device capable of inputting and/or outputting binary data.

The computer system 100 may further comprise one or more Advanced Programmable Interrupt Controllers (APIC), including one local APIC 110 per PCPU 120 and one or more I/O APICs 160. The local APICs 110 may receive interrupts from local sources (including timer interrupts, internal error interrupts, performance monitoring counter interrupts, thermal sensor interrupts, and I/O devices 140 connected to the local interrupt pins of the PCPU 120 either directly or via an external interrupt controller) and externally connected I/O devices 140 (i.e., I/O devices connected to an I/O APIC 160), as well as inter-processor interrupts (IPIs).

In a virtualization environment, the computer system 100 may be a host system that runs one or more virtual machines (VMs) 170a-b (generally or collectively, VM 170), by executing a hypervisor 190, often referred to as “virtual machine manager,” above the hardware and below the VMs 170, as schematically illustrated by FIG. 1. In one illustrative example, the hypervisor 190 may be a component of a host operating system 180 executed by the host computer system 100. Additionally or alternatively, the hypervisor 190 may be provided by an application running under the host operating system 180, or may run directly on the host computer system 100 without an operating system beneath it. The hypervisor 190 may represent the physical layer, including PCPUs 120, memory devices 130, and I/O devices 140, and present this representation to the VMs 170 as virtual devices.

Each VM 170a-b may execute a guest operating system (OS) 174a-b (generally or collectively, guest OS 174) which may use underlying VCPUs 171a-d (generally or collectively, VCPU 171), virtual memory 172a-b (generally or collectively, virtual memory 172), and virtual I/O devices 173a-b (generally or collectively, virtual I/O devices 173). A number of VCPUs 171 from different VMs 170 may be mapped to one PCPU 120 when overcommit is permitted in the virtualization environment. Additionally, each VM 170a-b may run one or more guest applications 175a-d (generally or collectively, guest applications 175) under the associated guest OS 174. The guest operating system 174 and guest applications 175 are collectively referred to herein as “guest software” for the corresponding VM 170.

In certain examples, processor virtualization may be implemented by the hypervisor 190 scheduling time slots on one or more PCPUs 120 for the various VCPUs 171a-d. In an illustrative example, the hypervisor 190 implements the first VCPU 171a as a first processing thread scheduled to run on the first PCPU 120a, and implements the second VCPU 171b as a second processing thread scheduled to run on the first PCPU 120a and the second PCPU 120b.

Device virtualization may be implemented by intercepting virtual machine memory read/write and/or input/output (I/O) operations with respect to certain memory and/or I/O port ranges, and by routing hardware interrupts to a VM 170 associated with the corresponding virtual device. Memory virtualization may be implemented by a paging mechanism allocating the host RAM to virtual machine memory pages and swapping the memory pages to a backing storage when necessary.

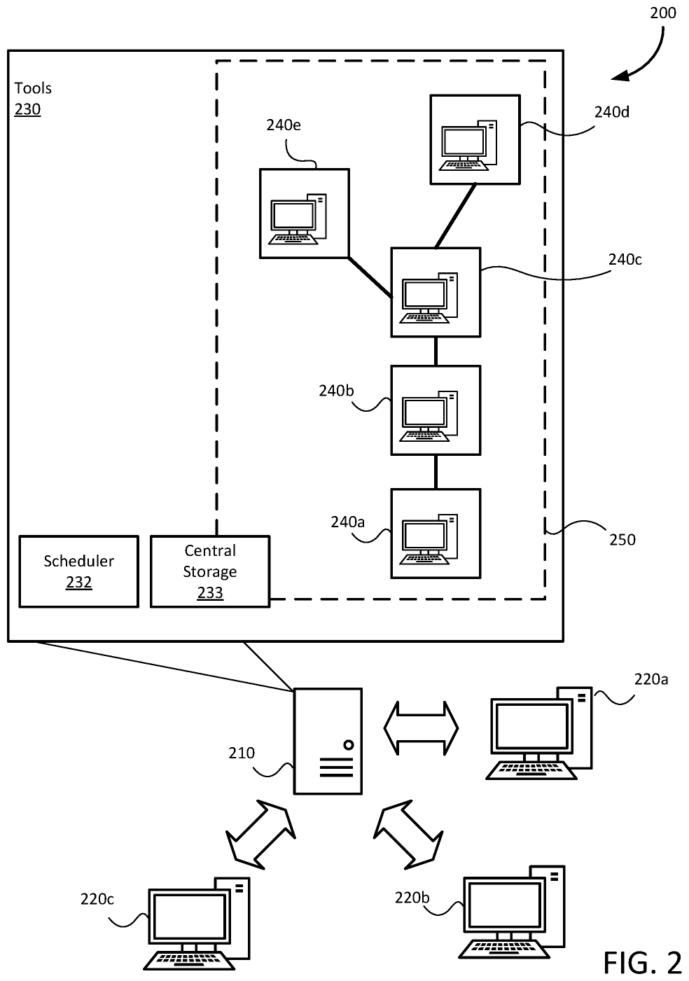

FIG. 2 illustrates a distributed computing environment 200, as may be accessed to manage, interact with, and test builds via the state-aware CI tools described herein, according to embodiments of the present disclosure.

Traditional CI/CD tools, which include various open source and commercially available components, are often built in the form of a distributed service (also referred to as a server/worker architecture). In the state aware computing environment 200, a server 210 and various worker nodes 220a-c (generally or collectively, worker nodes 220) use the tools 230, which include an internal scheduler 232 that matches requested states 240a-e (generally or collectively states 240) to specific worker nodes 220, where the processes are executed, and central storage 233, where one or more image pools 250 are stored for access by various worker nodes 220. Although three worker nodes 220 and five states 240 are shown in the present example, the present disclosure contemplates that different numbers of worker nodes 220 and/or states 240 can be used in various embodiments. In various embodiments, the server 210 may represent one or more physical or virtual computing devices, such as a platform providing the CI/CD automation software (e.g., a continuous integration server, such a Jenkins, Zuul, native Bash+cron, etc.), designated as a central repository or management system for the build environment 200. In various embodiments, the worker nodes 220 may represent various physical or virtual computing devices associated with various users with access to the build environment 200.

The server 210 includes a central storage 233, which alleviates the need for localized storage on each of the worker nodes 220 to host individual builds. Instead, builds are pooled in an image pool 250 for access by each of the worker nodes 220, which hosts the parent images (e.g., state 240a) uploaded manually for use into the image pool 250, and the child images (e.g., states 240b-e) that are developed as new states from the parent image.

In complex deployments, where the states 240 need specific demanding virtual and/or physical infrastructure to be prepared first so that testing can be executed in the right environment, such a distributed approach produces significant redundancy and repetition on worker nodes 220. The environmental and virtual infrastructure preparation for each state 240 is a complex task and might take hours or days (particularly if manual intervention is needed) to complete, and is done repetitively. More and more complex software products also take the initiative of preparation of sub-infrastructure (e.g., sub-deployments) as a main feature and therefore prolong the repetitive deployment times even further. This type of workload is performed repetitively by the worker nodes 220, which an astronomical amount of redundancy and significant timewise overhead compared to short the time really needed for actual testing of the software in such environments 200. Local storage of the worker nodes 220 is also utilized heavily to hold the different builds traditionally used by CI/CD tools. Complex deployments can also consist of several dependent stages with strict ordering, yet again prolonging the deployment time and increasing the redundancy.

The present disclosure reimagines the deployment step from traditional CI/CD processes and introduces and embeds state awareness into the build context. The present disclosure allows worker nodes 220 to create, store, restore, and operate over non-locally stored states that reside in the image pool 250 during a build itself. These states can include related metadata and related artifacts (e.g., build artifacts). The state represents the binary layout of the virtual node or nodes after some stage in some state 240 or even sets of these nodes together (e.g., a multi-node topology).

By introducing instant state restoration and features building (without redundancy) state dependencies using the non-destructive incremental COW (copy-on-write) approach, where no worker node 220 interferes with another as read operations go to the parent state, but write operations to the cloned child state specifically used by the worker, any of the worker nodes 220 can access and modify resources simultaneously, the present disclosure can result in significantly (by grades) faster re-deployments of selected states 240 in the software environment 200.

The present disclosure allows worker nodes 220 to share and/or reuse previously built deployments/states 240 and build artifacts as previously reached states that can be restored once stored to the image pool, whether these are states of the virtual nodes after some stage in some state 240 or even sets of these nodes together. By introducing instant storing, instant state restoration, and features building state dependencies using COW (copy-on-write) approach, where no worker node 220 interferes with another, but any of the worker nodes 220 can access and modify resources simultaneously, the present disclosure can result in faster re-deployments of selected states 240 in the software environment 200.

Each deployment stage is built once, and stored as a node in a linear structure or tree structure, which worker nodes 220 can access as a starting point for any states 240 or new code commits that users wish to test. This use of state-awareness drastically reduces the use of processor cycles by avoiding repetitive build tasks, and centralizes the storage and processing operations, among other benefits.

Accordingly, the worker nodes 220 can access existing states 240 in the structure, and add new states 240 to the structure for later access by themselves or others. For example, a first worker node 220a can access a second state 240b to use as a starting point for creating a third state 240c, which is added to the structure for later access. The second worker node 220b can then use the third state 240c as a starting point for creating a fourth state 240d, which is added to the structure for later access. By using earlier states 240 in the structure as starting points, the first and second worker nodes 220a-b in the present example incorporate the previously performed operations-allowing the first worker node 220a to avoid redoing to the work needed to generate the first and second states 240a-b when generating the third state 240c and allowing the second worker node 220b to avoid redoing to the work needed to generate the first through third states 240a-c when generating the fourth state 240d.

In another example, the third worker node 220c can access a third state 240c to use as a starting point for creating a fifth state 240e that is an alternative branch from the fourth state 240d. Similarly to the previous examples, the third worker node 220c can avoid redoing to the work needed to generate the first through third states 240a-c when generating the fifth state 240e. Accordingly, the various worker nodes 220 can identify various start positions to test or branch from that omit some later build states (e.g., the fourth state 240d) to develop new branches of software or environmental states for an image, or to focus on specifically desired elements to evaluate without duplicating previous resource expenditures.

In another example, when a user identifies a potentially useful intermediate state to two currently available states, the user can submit an update that builds from an earlier state, but does not extend to or surpass the later state. For example, the first worker node 220a can use the first state 240a as a starting point to generate a second state 240b that includes some, but not all of the differences that differentiate the third build 240c from the first state 240a. The second state 240b, therefore, may be stored to a shared storage hosting the image pool 250 as an intermediate state after both the first state 240a and the third state 240c have been stored to the image pool 250, such as when a user identifies the second state 240b to be a potentially useful common point from which to develop multiple branches for alternatives of the image. Stated differently, a user can add branches to an earlier state that already includes one or more branches, and these newly added states can include elements not present in the parent state, but are present in one or more currently-existing child states, elements not present in the currently-existing child states, and combinations thereof.

As used herein, the term “image” refers to a copy or binary of the structure and data stored in a storage device (whether physically or virtual). In various embodiments, the image may be a bit-by-bit copy, or may be compressed (e.g., by omitting unallocated sectors) or reformatted (e.g., defragmented).

Each of the states 240 provide an image/binary of the software under test/development at a given state. As users commit changes to the software, remove software from the environment, or add software to the environment, etc., new images (e.g., different states 240) are created, which the CI server 210 stores in a centrally accessible repository or build pool, and generates or updates the structure as a navigable state list or state tree to allow other users to access desired states. Users can determine which states are useful starting points for their work, and can avoid re-performing build actions to reach that starting point, and can instead rely on the earlier-performed work that generated that state. By reusing any states previously stored to the repository, user can skip the build actions needed to reach that state that users of traditional CI solutions had to perform; potentially saving significant time and computing resources.

Accordingly, by having all the reusable states of any virtualized (possibly even bare metal) infrastructure at instant disposal to the various worker nodes 220, a worker node 220 can build a new virtualized infrastructure from various states of that were originally generated by other worker nodes 220; mixing-in and/or borrowing such elements to create new combinatorial builds, in little time, even when the deployment of states 240 from which the parts combination is formed took hours or days to initially compile and set up, which is ideal for cross-product and portfolio testing.

One of ordinary skill in the relevant art will recognize that the advantages of the snapshotting/cloning/restore features discussed herein relative to the “naive” snapshotting traditionally used, where state is stored and exported from the local storage where the workload runs, then uploaded to destination and downloaded once needed. That traditional approach is suboptimal and adds significant overhead, often saturating local disk's input/output (IO) and network bandwidth, transferring significant amounts of data to/from the worker. The traditional approach does not remove redundancy as image states do not share references (parent-child) and the export of these images contains all the data needed to restore virtual machines, which usually means upwards of gigabytes of data per each snapshot made naively.

The present disclosure resolves these and other problems via a scalable solution with minimal to no redundancy by implementing the advanced storage capabilities (e.g., using Ceph rados block device (RBD) or other block storage features) of the distributed centralized storage solution introduced as part of the CI solution from the start. The improved snapshotting of the present disclosure is effective and scalable in complex environments, and includes maintaining an organization for the data generated by the worker nodes. In various embodiments, the storage provides separation between logically grouped states and access control (for example Ceph RBD or other namespace features), such as in various namespaces or other logical divisions.

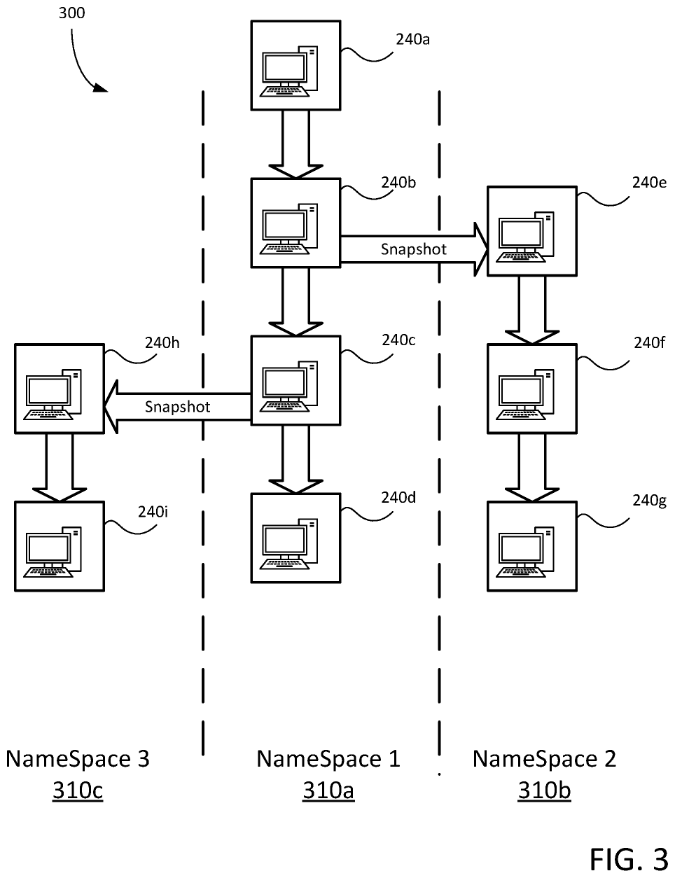

FIG. 3 illustrates one such logical division, according to embodiments of the present disclosure. The relationship structure 300 is built by snapshotting and cloning the images 240, may be understood as a tree structure where the direction from an initial image state (e.g., a root) leads to later/dependent images states (e.g., leaves). If the cloning feature is not used, the relationship structure 300 is an oriented list of related snapshots. When states from multiple namespaces 310a-c (generally or collectively, namespace 310) that branch from a shared state are mixed, the relationship structure 300 forms an oriented graph. States are cloned into a new namespace 310, where users can perform advanced storage operations on the clones of the images 240 prepared there, without interfering with the parent images 240 of those states (e.g., via different namespaces 310) due to the copy-on-write (COW) nature for the images 240 (e.g., where read operations go to the parent while write operations create or modify a child clone).

For example, assuming that state so is the initial state of the root/golden image 240a (uploaded and pre-prepared by a storage administrator), a later image 240b for state s₁ can be taken any point in time thereafter. A clone_s₁ image 240e is created from this later image 240b at state s₁, and retains the relation to the parent state of the image 240b at state s₁. From now on this clone_s₁ image 240e can be developed independently of the original image 240a/240b and reach different subsequent states (e.g., image 240f vs image 240c, image 240d vs. image 240g) without interfering with the advancement of the original image to subsequent states thereof (e.g., images 240b-240d from state s₁, to state s₂, to state s₃, etc. and clone images 240e-240g from state s₁ to state s₂ₐ, to state s_{3b}, etc.). As will be appreciated, a secondary clone of the clone image or of the original image may be taken at a subsequent times, thereby further branching the images 240 into further namespaces 310 that can each have distinct developmental states. For example, a third namespace 310c can branch off the first namespace 310a independently of the second namespace 310b.

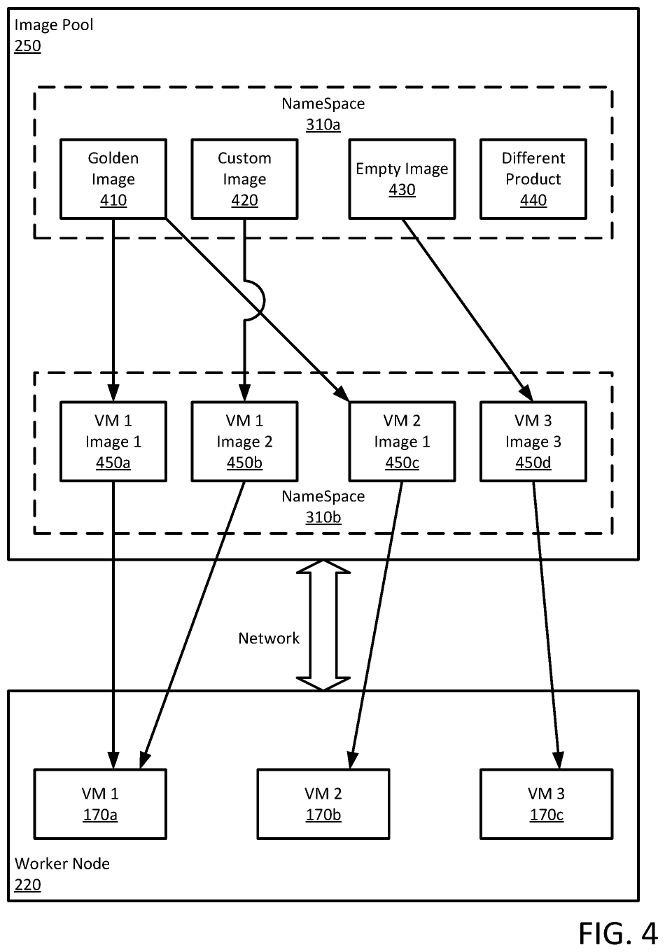

As shown in FIG. 4, a CI approach considers the comparability of builds (e.g., whether two builds share states in the steps of the builds) to identify a point in the relationship structure 300 that can be shared or repeated for the different builds. One CI build can manage/work with zero to N storage namespaces 310. Each build creates its own namespace 310 that the CI environment can keep ephemerally or permanently. These namespaces 310 are available over a network connection to the various worker nodes 220 from an image pool 250 that is accessible as shared storage by various worker nodes 220 at the same time (e.g., contemporaneously).

In such a workspace, the CI build prepares the image state requested by a worker node 200 by cloning existing states or the initial state of the root/golden images 410. The worker node or the CI build can perform CI runtime operations and also any operations storage layer offers. The various builds can use one or more images from a first namespace 310a to develop the VM images 450a-d (generally or collectively, VM images 450) that make up the second name space 310b, which may be used multiple times across the VM images 450.

As illustrated in the example given in FIG. 4, a golden image 410 from the first name space 310a is used in creating the first VM image 450a and the third VM image 450c, which are clones of the golden image 410 than can now diverge from one another and the golden image 410 (e.g., as images live on their own). The golden image 410 is an image prepared to be the root node that most of the required workloads will prepared tooling, preinstalled environments and the like from, and has no parent reference in the image pool.

A custom image 420, which may represent a state or image derived from the golden image 410 or dependent states processed to be some kind of importance to be quickly referenced (e.g., a flattened image with no parent reference), from the first namespace 310a is used to create the second VM image 450b, and the fourth VM image 450d, which further include an empty image 430 that does not contain a working runnable OS, or represents plain content, which can be used as a root node, and images 440 for different products or programs than represented by the other images 410-430 in the first namespace 310a. These images 440 for different products can be used as root nodes, by may represent imported images or topologies that include unknown contents but have been indicated as virtualized and reusable.

When the build is finished, the build environment can discard the namespace 310 completely or leave/retain the namespace for later use. When retaining the namespace 310, the workspace may provide CI artifacts and metadata alongside the build, preferably in file storage also provided by the storage solution or manually as another artifact, to help describe the state stored for later use.

The worker nodes mount only the remote file system provided by the central storage, which are provided on-the-fly. A Virtualization layer (e.g., libvirt) instantiates the VMs 170a-c from the pre-prepared images in the destination namespace 310b. A state represents the collection of images/snapshots present in the destination namespace 310b. These images/snapshots can be root images and/or snapshots of previous states, although preferably root images are only cloned from to create a clone/snapshot image that is later used by VMs 170 (e.g., the VMs 170 do not directly reference the root images, just clones thereof). A worker node 220 can also mix multiple states from multiple namespaces 310 and create a mixed multi-component/product environment, for example, as part of portfolio testing. Accordingly, any state of any build of any product in the central storage or image pool 250 can be restored and mixed together with others to instantiate VMs 170 from the identified namespaces 310, instantly and remotely, to build a unique runtime environment.

As illustrated in the example given in FIG. 4, a first VM 170a running on the worker node 220 is instantiated using the first image 450a and the second image 450b from the destination namespace 310b, while a second VM 170b is instantiated using the third image 450c, and a third image 170c is instantiated using a fourth image 450d. Although one worker node 220 is illustrated in FIG. 4, the present disclosure contemplates that multiple worker nodes 220 may access the same image pool 250 to create builds using the same or different namespaces 310. Additionally, the present disclosure contemplates that each worker node 220 may run more or fewer VMs 170 than shown in the example given in FIG. 4 using more or fewer VM images 450 made from different combinations of images and products according to the build specifications indicated by the user.

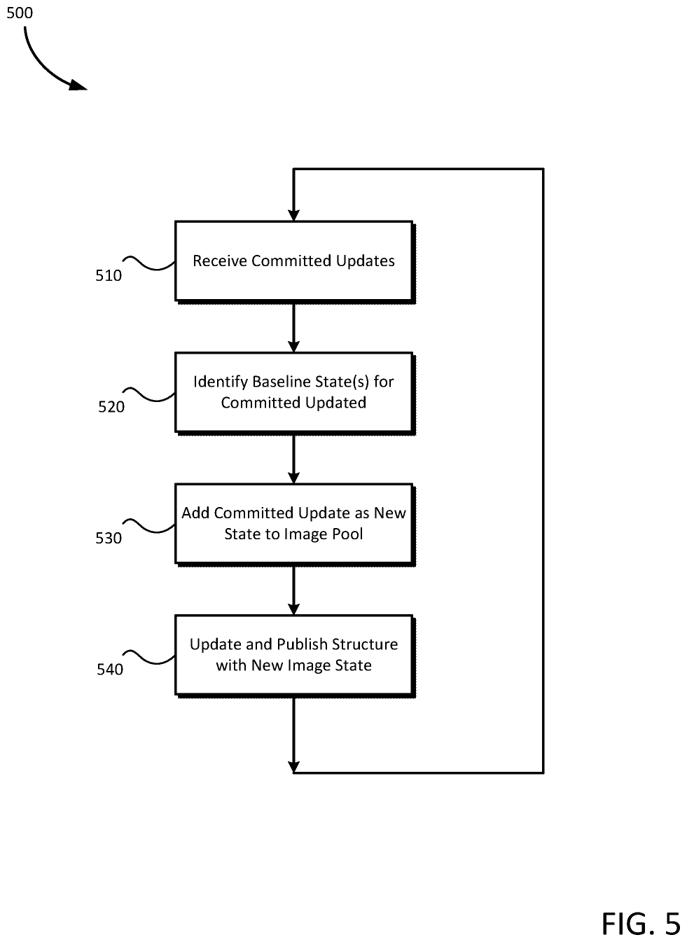

FIG. 5 is a flowchart of an example method 500 for providing state-aware continuous integration, according to embodiments of the present disclosure. Method 500 begins at block 510, where a server monitors for or is triggered by committed updates to an image (e.g., of a VM, a container, software, an environment or system) stored in a central image pool accessible by a plurality of worker nodes. The central image pool stores a plurality of states of the image that identify relationships to any earlier states of the build from which they are based.

At block 520, in response to identifying a committed update to the image, the server identifies which (if any) previous states of the image that the update is based on. For example, when the image is designated as a baseline state or initial image for a project on which future development may be based, the server may identify that there are no previous states for the image. In another example, when a worker node submits an update, the worker node may indicate to the server which previous state (or states) that the committed update is based on. In another example, the server may monitor which states of an image that a worker node requests from the collective pool, and base any committed updates from that worker node as being related to the requested previous states of the image.

At block 530, the server adds the update to the central image pool as a new state, or selectable build, indicating the dependencies (e.g., as identified per block 520) to any previous states in the build. In various embodiments, the server adds the new state to the linear or tree structure as a child node with a dependency to the identified parent states/images. In various embodiments, the new state may include various metadata from the worker node that made the commit, when the commit was made, various settings or features or comments about the state that differ from previous states, or the like, although the contents of the image itself as a state may be hidden.

At block 540, in response to adding the new image to the image pool, the server updates and publishes the update to the linear or tree structure, thereby allowing other worker nodes (or the original worker node at a later time) to access the new state in the context of the various states available in the project. Accordingly, a worker node can identify where in the scope of the project the new image is positioned (e.g., a update to an existing branch, a new branch, a new midpoint in an existing sequence), and if desired by the user, can request that image for use as a beginning state for further development or testing without having to rebuild the project up to that state. Additionally, other worker nodes can see in the updated structure that newly added state is available for use, and can use the newly added state as a candidate baseline state for future development. Method 500 may return to block 510 to continue to monitor for new updates to commit to the project.

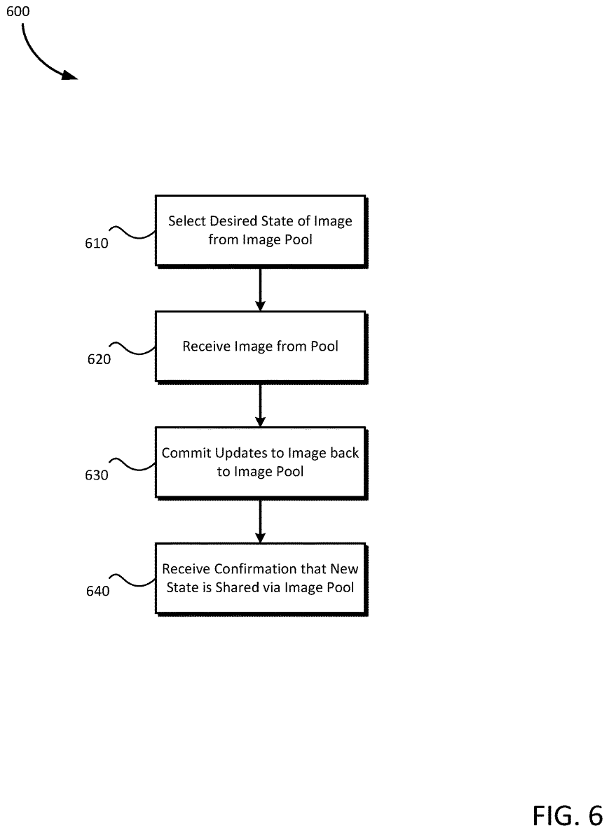

FIG. 6 is a flowchart of an example method 600 for using state-aware continuous integration, according to embodiments of the present disclosure. Method 600 begins at block 610, where a worker node selects, from a central image pool that is accessible by a plurality of worker devices (each with the ability to contemporaneously with one another read and write to various states for image stored in the central image pool), a certain state of the image. This certain state may be selected from a linear or tree structure that shows the relationships between a plurality of states for the image that have been made previously created, stored, produced, or advanced from worker nodes that previously generated (e.g., built, created, extended, etc.) the image in that state. Because the described approach for state-aware continuous integration allows for the reuse of different states of the image, explicit upload/download processes can be eliminated or reduced; allowing users to save to a central storage as a background process (e.g., autosave) or as a user-signaled process without implicating local storage.

At block 620, the worker node receives, from the server, the image according to the selected state (per block 610). The worker node may run various tests or provide additional updates to the selected as a starting point for further development. If the actions taken with the image do not result in any changes or updates that are committed back to the server hosting the image pool, method 600 may conclude after block 620.

At block 630, the worker node commits the updates made to the image (per block 620) from the initially selected state (per block 610) back to the server. In various embodiments, the server may verify the contents of the image, or query the worker node for various information or metadata for inclusion with the updates as a new state for the image, to allow other users to identify whether to use the new state as a starting point for further text or development.

At block 640, the worker node receives confirmation from the server that the new state has been successfully added to the plurality of build states accessible to the worker nodes, and that the new state that incorporates dependencies from the selected build state. Method 600 may then conclude.

Programming modules, may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable user electronics, minicomputers, mainframe computers, and the like. Embodiments may also be practiced in distributed computing environments where tasks are performed by remote processing devices that are linked through a communications network. In a distributed computing environment, programming modules may be located in both local and remote memory storage devices.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

It should be understood that various changes and modifications to the examples described herein will be apparent to those skilled in the relevant art. Such changes and modifications can be made without departing from the spirit and scope of the present subject matter and without diminishing its intended advantages. It is therefore intended that such changes and modifications be covered by the appended claims.

What is claimed is:

1. A method, comprising:
receiving, at a server from a first worker node, a committed update to an image stored in a central image pool accessible by a plurality of worker nodes that includes the first worker node;
identifying a dependency for the committed update to a baseline state of the image to which the committed update applies changes;
adding the committed update as a new state for the image to the central image pool;
updating a structure for the image according to the dependency for the new state to the baseline state; and
publishing the structure to the plurality of worker nodes to indicate that the new state is available for use in developing the image as a candidate baseline state.

2. The method of claim 1, further comprising:
receiving, at the server from a second worker node, a second committed update to the image stored in the central image pool accessible by the plurality of worker nodes that includes the second worker node;
identifying a second dependency for the second committed update to a second baseline state of the image to which the second committed update applies changes;
adding the committed update as a second new state for the image to the central image pool;
updating the structure for the image according to the second dependency for the second new state to the second baseline state; and
publishing the structure to the plurality of worker nodes to indicate that the second new state is available for use in developing the image as a second candidate baseline state.

3. The method of claim 2, wherein the second baseline state used by the second worker node is the new state submitted from the first worker node as the candidate baseline state.

4. The method of claim 1, wherein the structure is a tree structure, defining at least two branches from the baseline state.

5. The method of claim 1, wherein the baseline state is an intermediate state that includes dependencies to at least one earlier state in the structure.

6. The method of claim 1, wherein the baseline state includes at least one build previously submitted to the central image pool by worker nodes of the plurality of worker nodes, other than the first worker node.

7. The method of claim 1, wherein the server is a continuous integration server.

8. A method, comprising:
selecting, by a first worker node from a central image pool hosted by a server accessible by a plurality of worker nodes that includes the first worker node, a given state of an image;
receiving, by the first worker node from the server, the image according to the given state;
committing edits, made by the first worker node to the given state of the image, to the server; and
receiving confirmation of the edits from the server via an updated structure showing a new state corresponding to the edits, indicating dependency of the new state from the given state.

9. The method of claim 8, further comprising:
selecting, by the first worker node from the central image pool, the given state of the image;
receiving, by the first worker node from the server, the image according to the given state;
committing second edits, made by the first worker node to the given state of the image, to the server; and
receiving confirmation of the second edits from the server via a re-updated structure showing a second new state corresponding to the second edits, indicating dependency of the second new state from the given state, wherein the new state and the second new state are accessible as alternative branches from the given state.

10. The method of claim 8, wherein the edits include at least one of:
changes to code;
addition of a product to an environment;
removal of a product from the environment; or
changes of a setting within the environment.

11. The method of claim 8, wherein the given state and the new state are accessible from the central image pool as builds for worker nodes of the plurality of worker nodes.

12. The method of claim 8, wherein the server is a continuous integration server.

13. The method of claim 8, further comprising:
selecting, by a second worker node of the plurality of worker nodes from the central image pool, the given state of the image;
receiving, by the second worker node from the server, the image according to the given state;
committing second edits, made by the second worker node to the given state of the image, to the server; and
receiving confirmation of the second edits from the server via a re-updated structure showing a second new state corresponding to the second edits, indicating dependency of the second new state from the given state, wherein the new state and the second new state are accessible as alternative branches from the given state.

14. A system, comprising:
a server, including a processor and a memory including:
a central image pool, including a structure defining dependencies between a plurality of builds of an image; and
instructions, that when executed by the processor perform operations including:
receiving, from a first worker node, a committed update to an image stored in a central image pool accessible by a plurality of worker nodes that includes the first worker node;
identifying a dependency for the committed update to a baseline state of the image to which the committed update applies changes;
adding the committed update as a new state for the image to the central image pool;
updating a structure for the image according to the dependency for the new state to the baseline state; and
publishing the structure to the plurality of worker nodes to indicate that the new state is available for use in developing the image as a candidate baseline state.

15. The system of claim 14, the operations further comprising:
receiving, from a second worker node, a second committed update to the image stored in the central image pool accessible by the plurality of worker nodes that includes the second worker node;
identifying a second dependency for the second committed update to a second baseline state of the image to which the second committed update applies changes;
adding the committed update as a second new state for the image to the central image pool;
updating the structure for the image according to the second dependency for the second new state to the second baseline state; and
publishing the structure to the plurality of worker nodes to indicate that the second new state is available for use in developing the image as a second candidate baseline state.

16. The system of claim 15, wherein the second baseline state used by the second worker node is the new state submitted from the first worker node as the candidate baseline state.

17. The system of claim 14, wherein the structure is a tree structure, defining at least two branches from the baseline state.

18. The system of claim 14, wherein the baseline state is an intermediate state that includes dependencies to at least one earlier state in the structure.

19. The system of claim 14, wherein the baseline state includes at least one image state produced by a build previously submitted to the central image pool by worker nodes of the plurality of worker nodes, other than the first worker node.

20. The system of claim 14, wherein the server is a continuous integration server.
